(19) United States
(12) Patent Application Publication
(10) Pub. No.: US 2006/0244740 A1
(43) Pub. Date: Nov. 2, 2006

(54) DRIVING METHOD OF DUAL-SCAN MODE DISPLAY AND RELATED DISPLAY THEREOF

(76) Inventor: Chun-Fu Wang, Tainan County (TW)

Correspondence Address: NORTH AMERICA INTELLECTUAL PROPERTY CORPORATION, P.O. BOX 506, MERRIFIELD, VA, 22116, US

(21) Appl. No.: 11/307,880

(22) Filed: Feb. 27, 2006

(30) Foreign Application Priority Data
May 2, 2005 (TW) 094114135

(51) Int. Cl. G09G 5/00

(52) U.S. Cl. 345/204

(57) ABSTRACT

A method for driving a dual-scan mode display is disclosed. The dual-scan mode display includes a first driver IC and a second driver IC, and the method includes: utilizing the first driver IC to output a first signal according to a gray value to drive a first pixel to generate a first luminance value; utilizing the second driver IC to output a second signal according to the gray value to drive a second pixel to generate a second luminance value; and adjusting the first signal according to the first luminance value and the second luminance value to drive the first pixel to generate a third luminance value; wherein a difference between the third luminance value and the second luminance value is less than a threshold value.

### BACKGROUND OF THE INVENTION

1. Field of the Invention

The present invention relates to a driving method of a display and a related display, and more particularly, to a driving method capable of improving the display effect of a dual-scan mode display and related dual-scan mode display.

2. Description of the Prior Art

Organic light emission diodes (OLED) are new devices utilized for displays. The OLED has the characteristic of self-light-emitting. Therefore, in contrast to other displays (such as CRTs or LCDs), an OLED display can reduce the required number of parts, therefore making the cost of OLED display lower than conventional displays.

Modern displays need to show more and more information, meaning the display performance of a modern display is also required to be high. If the resolution of the display is high, however, this also means that the number of scan lines of the display should be increased. Considering a constant frame rate of 60 Hz, each scan line has little time to show line information. Therefore, in the application of a passive-matrix organic light emission diode (PMOLED), a dual-scan concept is disclosed to increase the charging/discharging time of a scan line.

Please refer to FIG. 1, which is a diagram of driving signals of a dual-scan mode PMOLED display according to the prior art. At the center of FIG. 1 is the display area 100 of the OLED display. As known by those skilled in the art, in the display area 100, the horizontal lines, composed of horizontal OLED pixels, are called scan lines, and the vertical lines, composed of vertical OLED pixels, are called data lines. Please note that the signals at the left of the display area are the driving signals received by the scan lines. As shown in FIG. 1, the scan lines are divided into a top area and a bottom area, which are respectively triggered by the same common signal. For example, when the scan signal encounters a falling edge, the corresponding scan line has to show the line information immediately. Therefore, in the display area 100, the corresponding scan lines of the top area and the bottom area (for example, the first scan line of the top area and the first scan line of the bottom area) show information simultaneously because the two scan lines correspond to the same triggering time.

In addition, for the data lines, the driver IC (not shown) generates corresponding signals according to the gray values to be displayed. As the scan lines are triggered according to divisions such as the top and bottom areas, two driver ICs are required to respectively send data signals to the top and bottom areas such that the entire display area 100 is able to show an image correctly.

In general, the above-mentioned data signals are pulse width modulation (PWM) signals. Please refer to FIG. 2, which is a diagram of a PWM signal. As known by those skilled in the art, the PWM signal 200 is outputted by a driver IC, where the pulse width of the PWM signal is determined according to the corresponding gray value. As shown in FIG. 2, if the corresponding gray value is small, the driver IC outputs a signal 210 having a narrower pulse width. On the other hand, if the corresponding gray value is large, the driver IC outputs a signal 220 having a wider pulse width. The gray value and the pulse width have a predetermined relationship; for example, if the gray value corresponds to 1, the pulse width corresponds to 2 clock cycles. Please note that the predetermined relationships between the gray value and the pulse width are well known, and thus omitted here for simplicity.

The above-mentioned display suffers a serious problem, however. As mentioned previously, two driver ICs are required, but the different driver ICs may be mismatched because the manufacturing processes or operating environments of the driver ICs are different. Therefore, when the driver ICs have to send data signals corresponding to the same gray value, the PWM signals outputted by the driver ICs may have different pulse widths or have different output voltages because the two driver ICs are mismatched. In other words, the output power of the two driver ICs are different so the pixels driven by different driver ICs may generate lights having different luminance. Furthermore, if the mismatch between the two driver ICs is more serious, the luminance difference between the OLED pixels driven by the driver ICs is also larger. For the observer, this makes the display area inconsistent between the top and bottom areas.

The prior art solution for the mismatch problem is to limit the allowable variation of parameters of the driver IC. Obviously, this solution directly influences the yield of the driver IC. Furthermore, as the technology progresses, the gray value will be required to have more and more levels. This means that the limitation of the parameters of the driver IC is more restrictive such that the driver IC becomes more difficult to manufacture. In short, the above-mentioned solution is not economical.

### SUMMARY OF THE INVENTION

It is therefore one of the primary objectives of the claimed invention to provide a driving method capable of improving the displaying effect of a dual-scan mode display and related display, to solve the above-mentioned problem.

According to an exemplary embodiment of the claimed invention, a method for driving a dual-scan mode display is disclosed. The dual-scan mode display comprises a first driver IC and a second driver IC, and the method comprises: utilizing the first driver IC to output a first signal according to a gray value to drive a first pixel to generate a first luminance value; utilizing the second driver IC to output a second signal according to the gray value to drive a second pixel to generate a second luminance value; and adjusting the first signal according to the first luminance value and the second luminance value to drive the first pixel to generate a third luminance value; wherein a difference between the third luminance value and the second luminance value is less than a threshold value.

According to another exemplary embodiment of the claimed invention, a dual-scan mode display is disclosed. The dual-scan mode display comprises: a first driver IC, for outputting a first signal according to a gray value to drive a first pixel to generate a first luminance value; a second driver IC, for outputting a second signal according to the gray value to drive a second pixel to generate a second luminance value; and a compensation module, coupled to the first driver IC, for adjusting the first signal according to the first luminance value and the second luminance value to drive the first pixel to generate a third luminance value; wherein a difference between the second luminance value and the third luminance value is less than a threshold value.

The present invention driving method of the dual-scan mode display and related display can compensate for the mismatch of two driver ICs such that the top display area and the bottom display area can be more consistent. Furthermore, the parameter limitations of the driver ICs can be less restrictive. This makes the driver IC have a better yield and thus reduces the cost of manufacturing the driver ICs.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of driving signals of a dual-scan mode passive-matrix organic light emission diode (PMOLED) display according to the prior art.

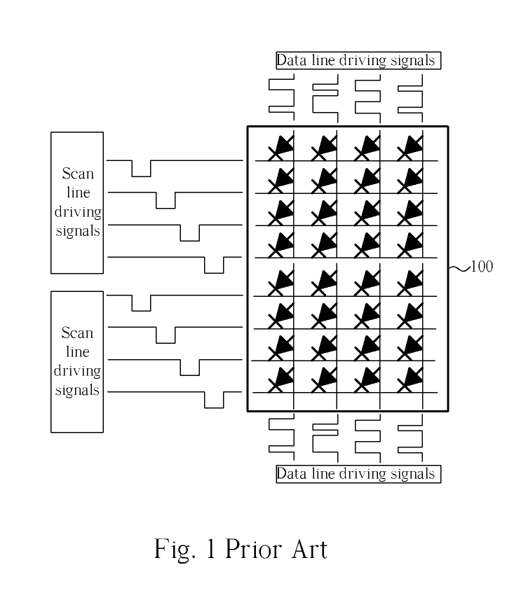

FIG. 2 is a diagram of a pulse width modulation (PWM) signal according to the prior art.

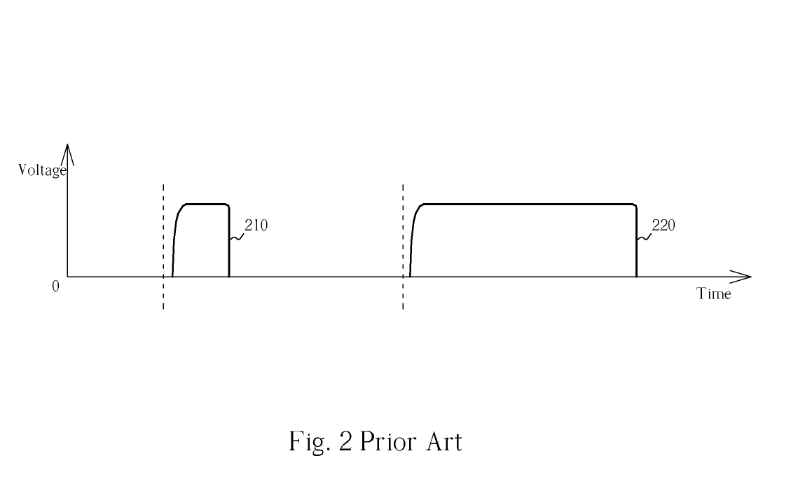

FIG. 3 is a comparative diagram of the present invention PWM signal and the prior art PWM signal.

FIG. 4 is a diagram of a PWM signal according to the present invention.

FIG. 5 is a diagram of a PWM signal of another embodiment according to the present invention.

FIG. 6 is a diagram of the PWM signal of another embodiment according to the present invention.

FIG. 7 is a functional block diagram of a dual-scan passive matrix OLED display according to the present invention.

FIG. 8 is a diagram of the compensation module and a part of the driver IC shown in FIG. 7.

FIG. 9 is a diagram of an operational clock and an output signal of the circuit shown in FIG. 8.

### DETAILED DESCRIPTION

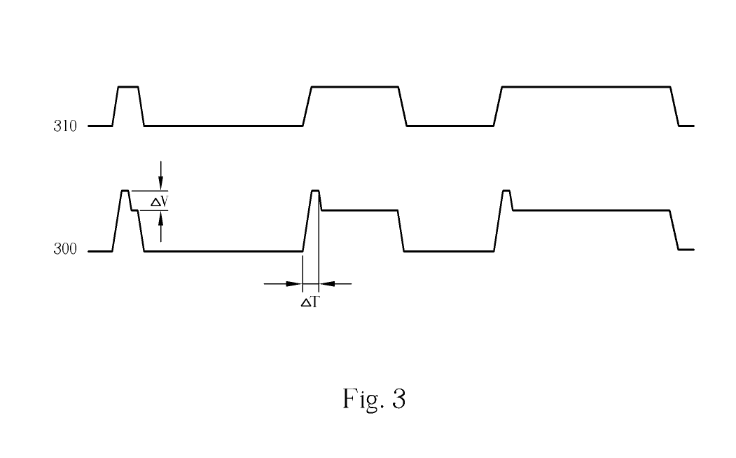

A novel driving method is disclosed to compensate for the mismatch between the driver ICs. Please refer to FIG. 3, which is a comparative diagram of the present invention PWM signal 300 and the prior art PWM signal 310. As mentioned previously, due to the mismatch between driver ICs, the output powers transferred to the pixels are different. In other words, the output power outputted by one of the driver ICs is smaller than that outputted by the other driver IC. Therefore, as shown in FIG. 3, the present invention PWM signal 300 further comprises a compensation signal ΔV (the bulge area in the pulse width) in each period. This means that the output power transferred to the pixel can be increased such that the luminance of the pixel can also be increased. The present invention can utilize the PWM signal 300 to compensate the driver IC having a smaller output power such that the power outputting difference between the two driver ICs can be eliminated. In this way, the mismatch between the two driver ICs can be removed.

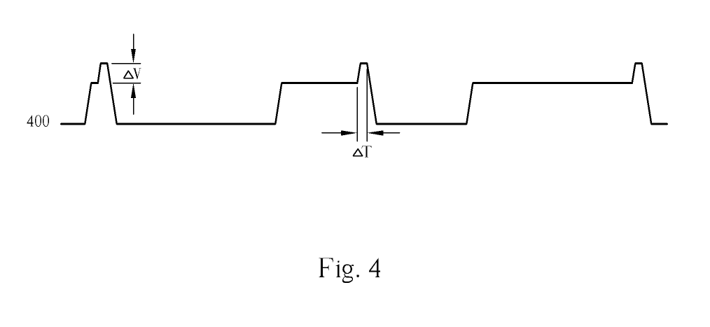

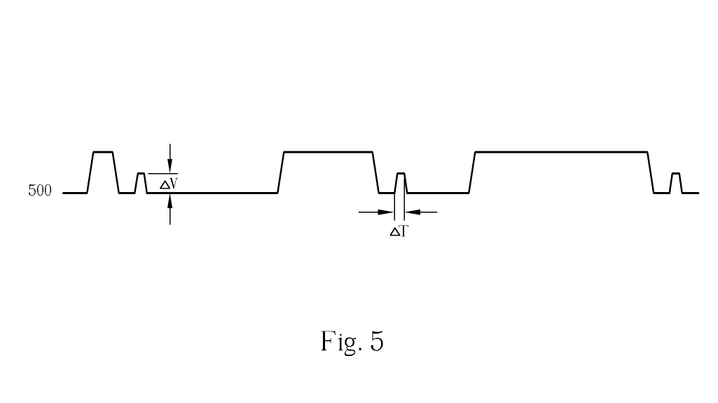

Please note that the present invention does not limit the location of the compensation signal in the PWM signal 300. For example, please refer to FIG. 4, which is a diagram of a PWM signal 400 according to the present invention. As shown in FIG. 4, in contrast to the PWM signal 300 having a compensation signal ΔV at the beginning of the pulse width, the PWM signal 400 has a compensation signal ΔV at the end of the pulse width. Please further refer to FIG. 5, which is a diagram of a PWM signal 500 of another embodiment according to the present invention. As shown in FIG. 5, in contrast to the PWM signals 300 and 400, the compensation signal ΔV of the PWM signal 500 does not lie in the pulse width. Instead, the compensation signal ΔV lies in the blank area. These changes also obey the spirit of the present invention. Please note that, as shown in FIG. 3, FIG. 4, and FIG. 5, the time duration of the compensation signal (this can also be regarded as the number of clock cycles corresponding to the compensation signal) is ΔT. Because the power of the compensation signal is proportional to ΔT and ΔV, this means that the present invention can adjust the output power of the PWM signals 300, 400, and 500 by adjusting ΔV and ΔT.

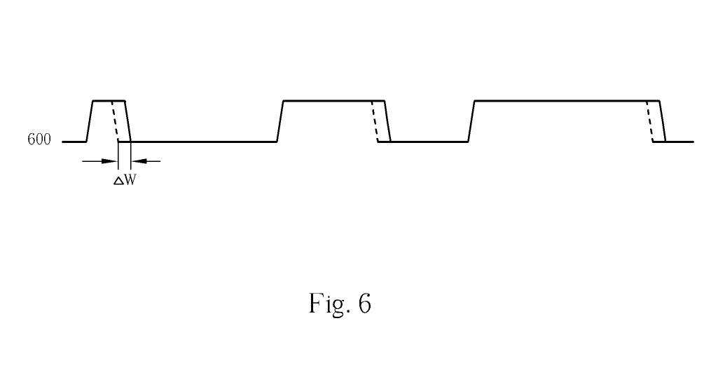

The present invention can increase the width of the pulse width to achieve the purpose of increasing output power. Please refer to FIG. 6, which is a diagram of the PWM signal 600. As shown in FIG. 6, the PWM signal 600 further comprises the pulse width ΔW in each original pulse width such that the output power can be increased.

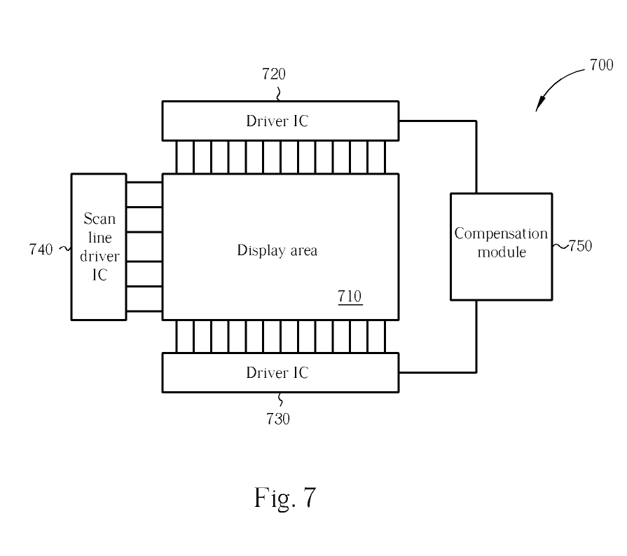

Please refer to FIG. 7, which is a functional block diagram of a dual-scan passive matrix OLED display 700 according to the present invention. As shown in FIG. 7, the dual-scan passive matrix OLED display 700 comprises a display area 710, two driver ICs 720 and 730, a scan line driver IC 740, and a compensation module 750. Furthermore, the scan line driver IC 740 is used to drive scan lines, which are utilized to show information. The driver ICs 720 and 730 are utilized to output PWM signals according to the gray values to be displayed. The PWM signals, as mentioned previously, can drive the pixels inside the display area 710. The compensation module 750 is coupled to the driver ICs 720 and 730 for compensating for the mismatch between the driver ICs 720 and 730. Please note that other conventional devices (such as a timing controller) are not shown in the dual-scan mode passive OLED display 700 for simplicity.

Although the driver ICs 720 and 730 have to output PWM signals corresponding to the same gray value, the driver ICs 720 and 730 will still output different PWM signals to drive pixels due to the mismatch between the driver ICs 720 and 730. Therefore, in the present invention, a luminance detecting module (not shown) can be utilized to detect the luminance difference between pixels driven by different driver ICs. Please note that the operation and function of the above-mentioned luminance detecting module is already known by those skilled in the art, and is thus omitted here.

When the luminance difference is larger than a predetermined threshold, the mismatch between the driver ICs has to be compensated for. Therefore, the luminance detecting module drives the compensation module 750 to output a compensation signal to adjust the PWM signals outputted by the driver IC 720 or the driver IC 730. It should be noted that the function of the compensation signal has been disclosed previously. For example, a pulse signal can be added or the width of the pulse width can be increased in order to increase the power outputted to the pixels.

After the above-mentioned compensation step, the driver ICs 720 and 730 can drive pixels to generate similar lights according to the same gray value. Therefore, the inconsistency between the top and bottom display area 710 can be removed.

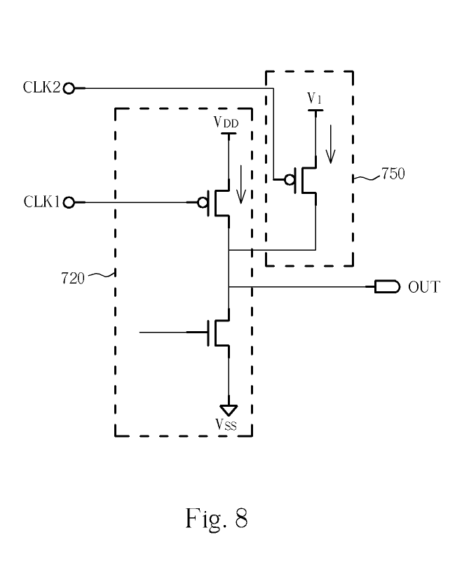

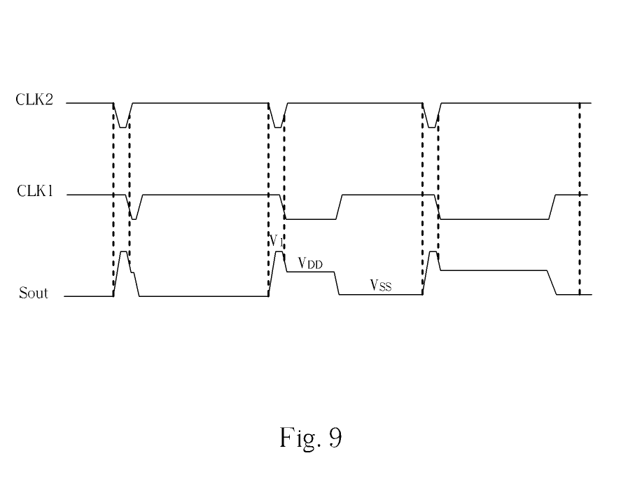

In the following disclosure, a circuit will be disclosed to implement the above-mentioned compensation module 750. Please refer to FIG. 8 and FIG. 9. FIG. 8 is a diagram of the compensation module 750 and a part of the driver IC 720 shown in FIG. 7. FIG. 9 is a diagram of an operational clock and an output signal of the circuit shown in FIG. 8. Please note that only the circuit belonging to the data line output buffer inside the driver IC 720 and the compensation module 750 are shown in FIG. 8. Here, assume that the driver IC 720 needs to be compensated. As shown in FIG. 8, the driver IC 720 comprises a PMOS utilized as a switch, which is operated according to an operational clock CLK1 in order to transfer the reference voltage V_{DD} to the output end. The compensation module 750 is also a PMOS, which is operated according to another operational clock CLK2 for transferring a compensation voltage V₁ to the output end in order to compensate the signal (voltage) outputted by the driver IC 720. As shown in FIG. 9, it can be clearly seen that the operational clock CLK1 has different pulse widths W1, W2, and W3, which respectively correspond to different gray values to be outputted, so the waveform of the signal outputted by the driver IC 720 can correspond to the pulse widths of the operational clock CLK1. Based on the above-mentioned assumption, however, as the output power of the driver IC 720 is less than that of the driver IC 730, the compensation module 750 will turn on the PMOS inside the compensation module 750 according to the signal (the reference clock CLK2) outputted by the luminance detecting module. This means the compensation voltage V₁ will be transferred to the output end due to the operational clock CLK2, and the voltage of the output end will have a bulge in each pulse width as the signal S_{OUT} shown in FIG. 9. Furthermore, the bulge is generated because the compensation voltage V₁ is added in the original PWM signal outputted by the driver IC 720. In addition, the time duration of the compensation voltage V₁ can be controlled by adjusting the operational clock CLK2. As the operational clock CLK2 can be generated by the digital logic circuit inside the driver IC 720, and those skilled in the art already know how the method of adjusting the operational clock CLK2, further illustration is omitted here.

The present invention driving method and related circuit can be implemented to compensate for the mismatch between two driver ICs, and to remove the inconsistency between the top display area and the bottom display area.

Please note, in the above disclosure, a compensation signal is added in the PWM signal to increase the luminance of the pixel. Another compensation method of subtracting a compensation signal from the PWM signal can also be utilized. In other words, the circuit, which is originally used for outputting the compensation signal, can output an inversed compensation signal to make the power of the PWM signal become smaller. This change also obeys the spirit of the present invention.

It should be noted that in the above disclosure, the passive matrix OLED display is utilized as an illustration. However, the present invention can be utilized in all kinds of dual-scan mode displays to compensate for a mismatch between driver ICs. In other words, the passive matrix OLED display is only utilized as an embodiment, and not a limitation of the present invention.

In contrast to the prior art, the present invention driving method of the dual-scan mode display and related display can compensate for the mismatch of two driver ICs such that the top display area and the bottom display area can be more consistent. Furthermore, the parameter limitations of the driver ICs can be less restrictive. This makes the driver IC have a better yield and reduces the costs of manufacturing the driver ICs.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for driving a dual-scan mode display, the dual-scan mode display comprising a first driver IC and a second driver IC, and the method comprising:
utilizing the first driver IC to output a first signal according to a gray value to drive a first pixel to generate a first luminance value;
utilizing the second driver IC to output a second signal according to the gray value to drive a second pixel to generate a second luminance value; and
adjusting the first signal according to the first luminance value and the second luminance value to drive the first pixel to generate a third luminance value;
wherein a difference between the third luminance value and the second luminance value is less than a threshold value.

2. The method of claim 1, wherein the first signal and the second signal are both pulse width modulation (PWM) signals, and the step of adjusting the first signal further comprises:
adjusting a pulse width of the first signal.

3. The method of claim 1, wherein the first signal and the second signal are both pulse width modulation (PWM) signals, and the step of adjusting the first signal further comprises:
providing a pulse in each period of the first signal to adjust the first signal.

4. The method of claim 1, wherein the dual-scan mode display is a dual-scan mode passive matrix organic light emission display.

5. A dual-scan mode display comprising:
a first driver IC, for outputting a first signal according to a gray value to drive a first pixel to generate a first luminance value;
a second driver IC, for outputting a second signal according to the gray value to drive a second pixel to generate a second luminance value; and
a compensation module, coupled to the first driver IC, for adjusting the first signal according to the first luminance value and the second luminance value to drive the first pixel to generate a third luminance value;
wherein a difference between the second luminance value and the third luminance value is less than a threshold value.

6. The dual-scan mode display of claim 5, wherein the first signal and the second signal are both pulse width modulation (PWM) signals, and the compensation module adjusts a pulse width of the first signal to adjust the first signal.

7. The dual-scan mode display of claim 5, wherein the first signal and the second signal are both pulse width modulation (PWM) signals, and the compensation module provides a pulse in each period of the first signal to adjust the first signal.

8. The dual-scan mode display of claim 5, wherein the dual-scan mode display is a dual-scan mode passive matrix organic light emission display.
